(19) United States
(12) Patent Application Publication
(10) Pub. No.: US 2012/0296730 A1
(43) Pub. Date: Nov. 22, 2012

(54) METHODS AND SYSTEMS FOR GAMIFYING COUPON OFFERINGS

(75) Inventor: Anand T. Xavier, Bangalore (IN)

(73) Assignee: Yahoo! Inc., Sunnyvale, CA (US)

(21) Appl. No.: 13/111,763

(22) Filed: May 19, 2011

(51) Int. Cl. G06Q 30/00

(52) U.S. Cl. 705/14.35; 705/14.1

(57) ABSTRACT

Techniques are provided which engage users and increase social interaction in group buying. Methods and systems may offer one or more discount coupons for sale in a plurality of geographic locations. The number of coupons sold in each geographic location may be determined, and the geographic locations where at least a predetermined minimum number of coupons have been sold may be selected. A discount amount for coupons sold in each of the selected geographic locations may be determined and set based at least in part on the number of coupons sold in each respective geographic location.

### BACKGROUND

Recently, group buying has been increasing in popularity. However, group buying platforms generally do not allow users to be involved in the process other than merely buying the advertised product or service. Allowing users to promote a group sale, for example, will increase user engagement and thereby increase advertiser visibility.

There is a need for techniques in online advertising relating to, among other things, increasing social interaction among users who participate in group buying to increase advertiser visibility.

### SUMMARY

Some embodiments of the invention provide systems and methods in which one or more discount coupons may be offered for sale substantially simultaneously in a plurality of geographic locations for a predetermined period of time.

In some embodiments, once the coupons are offered for sale in one or more geographical locations, the current sales for one or more locations, the required minimum number of sales for one or more locations and the designated discount amounts for the locations with the top sales (e.g., top third, second third, bottom third) may be displayed. This information may be displayed, for example in the form of a “heat map”. This may entice users to participate in the buying process by purchasing more coupons themselves, or by encouraging members of their social network to purchase more coupons to increase the ranking of their location and/or to reach the required minimum number of sales for their location. For example, users may promote the sale of coupons on their social networking platform, send emails and/or IMs promoting the sale of coupons, etc.

In some embodiments, one or more geographic locations where at least a predetermined minimum number of coupons have been sold are selected. A discount amount for coupons sold in each of the selected geographic locations where the predetermined minimum number of coupons were sold may be determined and set based at least in part on the number of coupons sold in each respective geographic location. For example, the discount amount for a coupon sold in each selected geographic location may be determined based at least in part by comparing the number of sales of that coupon in each selected respective geographic location to the number of sales of that coupon in other selected geographic locations during the same time period.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention; and

FIG. 5 is a block diagram illustrating one embodiment of the invention.

### DETAILED DESCRIPTION

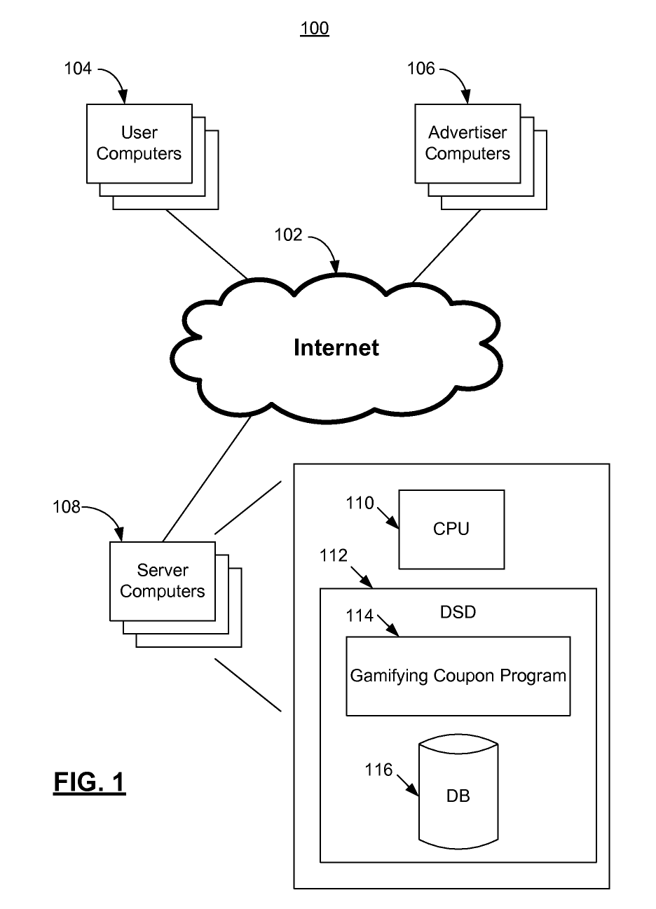

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers 104 may be or include desktop or laptop PCs, as well as, wireless, mobile, or handheld devices such as cell phones, PDAs, tablets, etc.

Each of the one or more computers 104, 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, coupons, promotions, social networking related advertisements, etc.

As depicted, each of the server computers 108 includes one or more CPUs 110 and a data storage device 112. The data storage device 112 includes a database 116 and a Gamifying Coupon Program 114.

The elements of the Program 114 may exist on a single server computer or be distributed among multiple computers or devices.

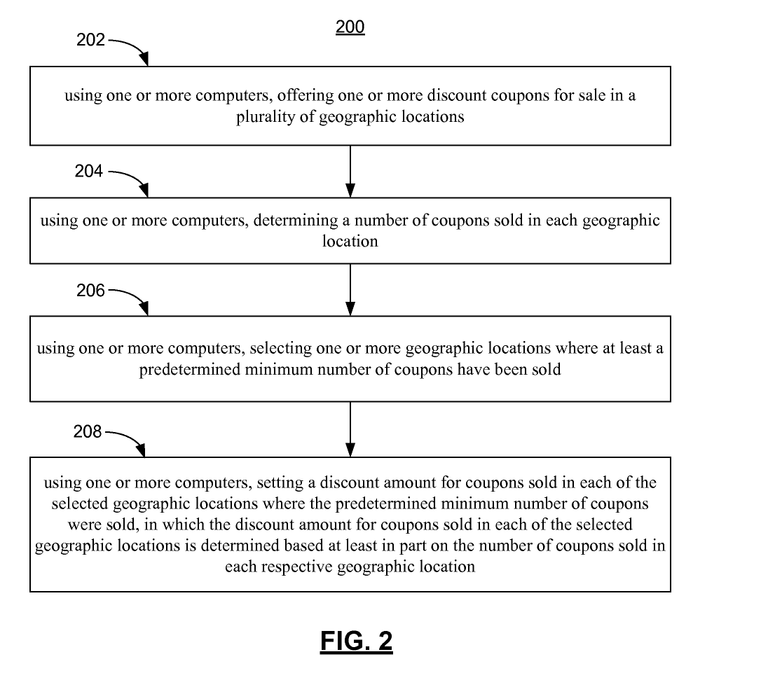

FIG. 2 is a flow diagram illustrating a method 200 according to one embodiment of the invention. At step 202, using one or more computers, one or more discount coupons are offered for sale in a plurality of geographic locations. A geographic location may be a country, city, state, neighborhood, city block, etc. Each discount coupon may enable a purchaser of the discount coupon to receive a discount on a specified product or service. The discount coupons may be offered for sale substantially simultaneously at each of the geographic locations. It should be noted that a discount coupon as described in this disclosure is not limited to, and does not need to resemble a traditional offline print coupon. For example, in some embodiments, a discount coupon may include a gift certificate for a specified amount. Alternatively, a discount coupon may be a commitment to purchase a specified item. The one or more discount coupons may be provided by, for example, one or more advertiser computers 106 (FIG. 1), by one or more server computers 108 (FIG. 1), or in combination by one or more server computers 108 and one or more advertiser computers 106.

At step 204, using one or more computers, a number of coupons sold in each geographic location is determined.

At step 206, using one or more computers, one or more geographic locations where at least a predetermined minimum number of coupons have been sold are selected.

At step 208, using one or more computers, a discount amount for coupons sold in each of the selected geographic locations where the predetermined minimum number of coupons were sold is determined and set. The discount amount for coupons sold in each of the selected geographic locations is determined based at least in part on the number of coupons sold in each respective geographic location. For example, the discount amount for a coupon sold in each selected geographic location may be determined based at least in part by comparing the number of sales of that coupon in each respective geographic location to the number of sales of that coupon in other geographic locations during the same time period.

In some embodiments, comparison of number of sales can be other than a simple unadjusted quantity comparison. For example, in some embodiments, a proportionality may be utilized. For example, in some embodiments, a proportionality may be made based on population, such that, if a first region has twice the population of a second region, then comparing the relative coupon sales numbers could include providing a higher discount to the first region only if the number of coupon sales for the first region is twice that of the second region, to provide proportionality based on population, etc. Of course, many different factors, adjustments or proportionalities may be utilized, and may apply to minimum thresholds for regions as well.

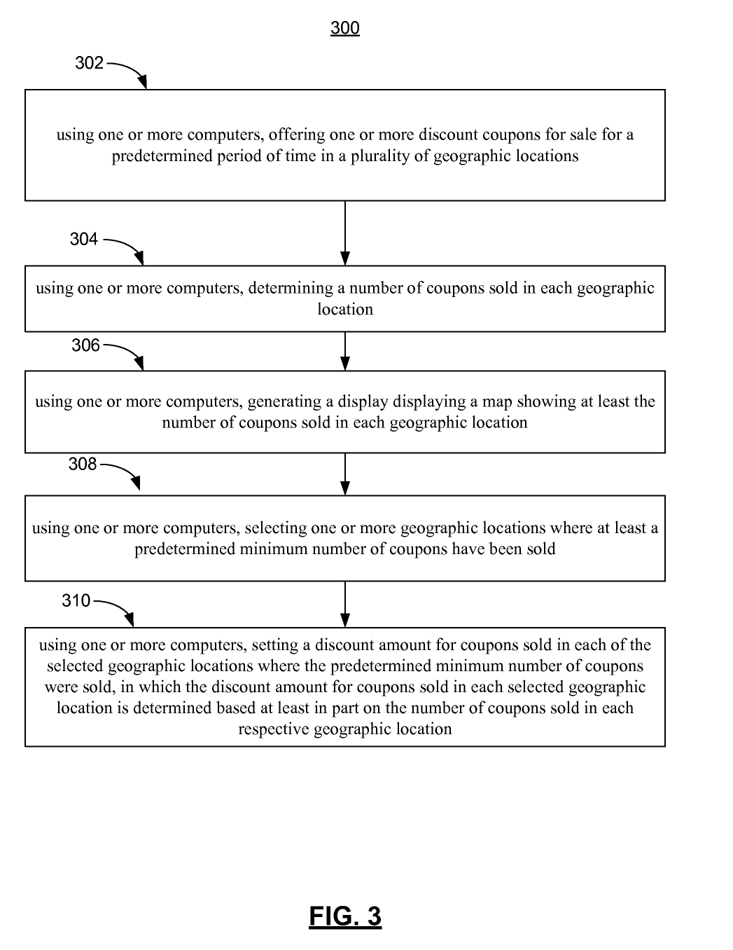

FIG. 3 is a flow diagram illustrating a method 300 according to one embodiment of the invention. At step 302, using one or more computers, one or more discount coupons are offered for sale for a predetermined period of time in a plurality of geographic locations. The discount coupons may be offered for sale substantially simultaneously at each of the geographic locations.

At step 304, using one or more computers, the number of coupons sold in each geographic location is determined.

At step 306, using one or more computers, a display displaying a map showing at least the number of coupons sold in each geographic location is generated. The display may be generated by, for example, one or more server computers 108 (FIG. 1) and may be viewed by a user on, for example, one or more user computers 104 (FIG. 1). In some embodiments, the current sales for one or more locations, the required minimum number of sales for one or more locations and the designated discount amounts for the locations with the top sales (e.g., top third, second third, bottom third) may be displayed. This information may be displayed, for example in the form of a “heat map”. This may entice users to participate in the buying process by purchasing more coupons themselves, or by encouraging members of their social network to purchase more coupons to increase the ranking of their location and/or to reach the required minimum number of sales for their location. For example, users may promote the sale of coupons on their social networking platform, send emails and/or IMs promoting the sale of coupons, etc.

At step 308, using one or more computers, one or more geographic locations where at least a predetermined minimum number of coupons have been sold are selected.

At step 310, using one or more computers, a discount amount for coupons sold in each of the selected geographic locations where the predetermined minimum number of coupons were sold is determined and set. The discount amount for coupons sold in each selected geographic location may be determined based at least in part on the number of coupons sold in each respective geographic location. For example, the discount amount for a coupon sold in each selected geographic location may be determined based at least in part by comparing the number of sales of that coupon in each selected respective geographic location to the number of sales of that coupon in other selected geographic locations during the same time period.

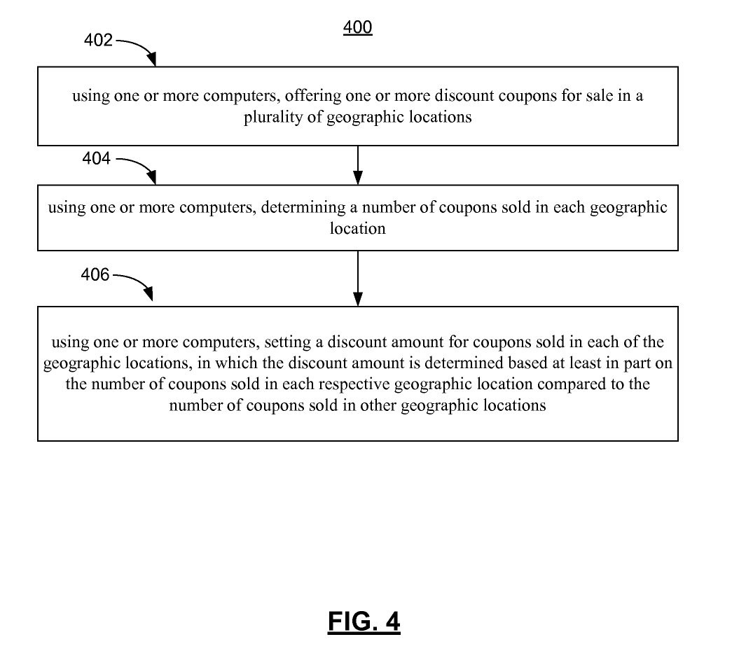

FIG. 4 is a flow diagram illustrating a method 400 according to one embodiment of the invention. At step 402, using one or more computers, one or more discount coupons are offered for sale in a plurality of geographic locations. The discount coupons may be offered for sale substantially simultaneously at each of the geographic locations.

At step 404, using one or more computers, the number of coupons sold in each geographic location is determined.

At step 406, using one or more computers, a discount amount for coupons sold in each of the geographic locations is determined and set. The discount amount for coupons sold in each geographic location may be determined based at least in part on the number of coupons sold in each respective geographic location. For example, the discount amount for a coupon sold in each geographic location may be determined based at least in part by comparing the number of sales of that coupon in each respective geographic location to the number of sales of that coupon in other geographic locations during the same time period.

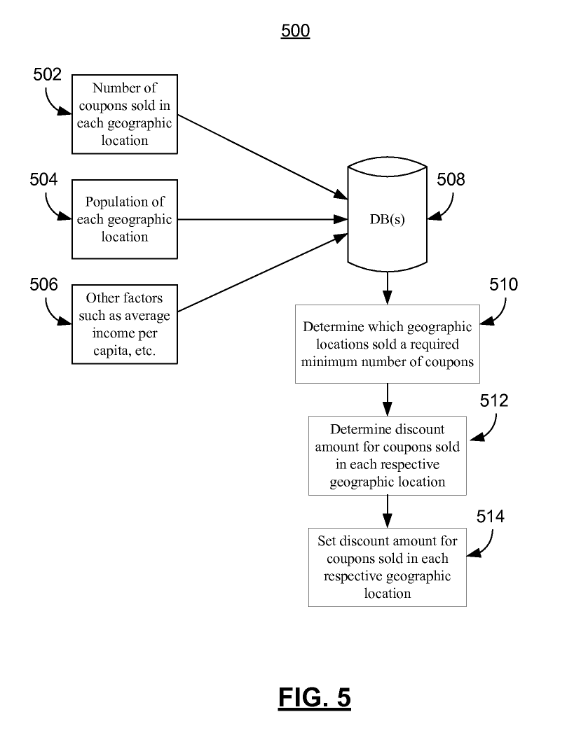

FIG. 5 is a block diagram 500 illustrating one embodiment of the invention. One or more data stores or databases 508 are depicted. Various types of information are stored in the database 508, which information may be obtained, gathered, or generated in various ways. Database 508 may be located in, for example, one or more server computers 108 (FIG. 1) and/or one or more advertiser computers 106 (FIG. 1). In particular, types of depicted information stored in database 508 include number of coupons sold in each geographic location 502, population of each geographic location 504 and other factors such as average income per capita, etc. 506. In accordance with exemplary embodiments, multiple coupons may be offered for sale simultaneously. For example, a coupon for Macy's may be offered for sale during a 3-day period and a coupon for Bloomingdale's may also be offered for sale during the same 3-day period. Alternatively, the Macy's and Bloomingdale's coupons may be offered for sale during different or overlapping time periods. Number of coupons sold in each geographic location 502 may include sales figures for each type of coupon that is offered for sale. Using the above example, a discount amount for the Macy's coupons may be determined based at least in part on, number of coupons sold 502, which may include the number of Macy's coupons sold during the 3-day period. Similarly, a discount amount for the Bloomingdale's coupons may be determined based at least in part on, number of coupons sold 502, which may include the number of Bloomingdale's coupons sold during the 3-day period.

As depicted in block 510, one or more of these types of information, possibly among other types, maybe used to determine which geographic locations sold a required minimum number of coupons. The required minimum number of coupons may be a fixed amount for all geographic locations that offered a certain coupon for sale. For example, a Macy's coupon may be offered for sale in every city in NY. The required minimum may be fixed at 1000 coupons, such that every city must have at least 1000 sales in order for the coupons sold in that city to qualify for a certain discount amount. Alternatively, the required minimum number of coupons may vary for each geographic location and may be determined based on factors such as, for example, population of that geographic location 504, average household income in that geographic location 506, or other factors. For example, if New York City has a population of 5 million people, and Buffalo has a population of 1 million people, the required minimum of number of coupons sold for New York City may be set to 5000 coupons, whereas the required minimum of number of coupons sold for Buffalo may be set to 1000 coupons. In some embodiments, there may be no required minimum. For example, coupons sold in each geographic location may qualify for a certain discount regardless of how many coupons were sold in each respective geographic location.

As depicted at block 512, discount amounts for coupons sold in each respective geographic location may be determined based at least in part on one or more of these types of information. For example, a Macy's gift certificate with a $300 value may be offered for sale in every city in NY State for a 3-day period. The gift certificate may be advertised with a discount between 5% and 10%. After the 3-day period ends, the number of sales in every city may be tallied. The cities that met the minimum required number of sales may be selected. As previously discussed, the minimum number of sales may be a fixed amount for all cities, or may be adjusted for each city to account for, population, average household income, etc. Alternatively, there may be no minimum and every city where at least one coupon was sold may be selected. The selected cities may be ranked according to the number of sales of coupons in each city. Discount amounts for coupons sold in each of the selected cities may be determined and set based at least in part on the number of coupon sales in that city compared to the number of coupon sales in the other selected cities. For example, coupons sold in cities that had the top ⅓^{rd} in sales may be designated a 10% discount, coupons sold in cities that had the second ⅓^{rd} in sales may be designated a 7.5% discount, and coupons sold in cities that had the bottom ⅓^{rd} in sales may be designated a 5% discount. In the above example, coupons that are designated a 10% discount would receive the gift certificate ($300 value) for $270, coupons that are designated a 7.5% discount would receive the gift certificate for $277.50, and coupons that are designated a 5% discount would receive the gift certificate for $285. Alternatively, coupons sold in every city that exceeds the minimum number of coupon sales may be designated the maximum 10% discount, and coupons sold in every other city may be designated a lesser (e.g., 7.5%) discount, or may even get no discount. When users initially commit to purchase the coupons, they may be charged the whole amount (e.g., $300), and once it is determined how much of a discount they receive based on the number of coupons sold in their city, the discount amount may be credited back to the user. In the above example, a user may be charged $300 for the gift certificate, and if the user is in the city that had the top ⅓^{rd} in sales, the user would be refunded 10% of the purchase amount (e.g., $30). Alternatively, a hold may be placed on the user's credit card initially for the full amount (e.g., $300), and once the discount amount is determined, the discounted amount (e.g., $270) may be charged to the credit card.

In some embodiments, once the coupons are offered for sale in one or more geographical locations, the current sales for one or more locations, the required minimum number of sales for one or more locations and the designated discount amounts for the locations with the top sales (e.g., top third, second third, bottom third) may be displayed. This information may be displayed, for example in the form of a “heat map”. This may entice users to participate in the buying process by purchasing more coupons themselves, or by encouraging members of their social network to purchase more coupons to increase the ranking of their location and/or to reach the required minimum number of sales for their location. For example, users may promote the sale of coupons on their social networking platform, send emails and/or IMs promoting the sale of coupons, etc.

While the invention is described with reference to the above drawings, the drawings are intended to be illustrative, and the invention contemplates other embodiments within the spirit of the invention.

1. A method comprising:
using one or more computers, offering one or more discount coupons for sale in a plurality of geographic locations;
using one or more computers, determining a number of coupons sold in each geographic location;
using one or more computers, selecting one or more geographic locations where at least a predetermined minimum number of coupons have been sold; and
using one or more computers, setting a discount amount for coupons sold in each of the selected geographic locations where the predetermined minimum number of coupons were sold, wherein the discount amount for coupons sold in each of the selected geographic locations is determined based at least in part on the number of coupons sold in each respective geographic location.

2. The method of claim 1, further comprising:
using one or more computers, generating a display displaying the number of coupons sold in each geographic location and the predetermined minimum number of coupons.

3. The method of claim 1, wherein the one or more discount coupons are offered for sale for a predetermined period of time.

4. The method of claim 1, further comprising:
using one or more computers, generating a display displaying a map showing the number of discount coupons sold in each geographic location.

5. The method of claim 1, wherein the one or more discount coupons are provided by one or more advertisers.

6. The method of claim 1, further comprising:
using one or more computers, allowing a purchaser of a discount coupon to promote the sale of the one or more discount coupons on a social networking platform.

7. The method of claim 1, wherein each geographic location is a city.

8. The method of claim 1, wherein each geographic location is a state.

9. The method of claim 1, wherein the discount amount for coupons sold in each selected geographic location is determined based at least in part by comparing the number of coupons sold in each selected respective geographic location with the number of coupons sold in one or more other selected geographic locations.

10. A system comprising:
one or more server computers coupled to a network; and
one or more databases coupled to the one or more server computers;
wherein the one or more server computers are for:
offering one or more discount coupons for sale in a plurality of geographic locations;
determining a number of coupons sold in each geographic location;
selecting one or more geographic locations where at least a predetermined minimum number of coupons have been sold; and
setting a discount amount for coupons sold in each of the selected geographic locations where the predetermined minimum number of coupons were sold, wherein the discount amount for coupons sold in each selected geographic location is determined based at least in part on the number of coupons sold in each respective geographic location.

11. The system of claim 10, wherein the one or more server computers are for:
generating a display displaying the number of coupons sold in each geographic location and the predetermined minimum number of coupons.

12. The system of claim 10, wherein the one or more discount coupons are offered for sale for a predetermined period of time.

13. The system of claim 10, wherein the one or more server computers are for:
generating a display displaying a map showing the number of coupons sold in each geographic location.

14. The system of claim 10, wherein the one or more discount coupons are provided by one or more advertisers.

15. The system of claim 10, wherein the one or more server computers are for:
allowing a purchaser of the discount coupon to promote the sale of the one or more discount coupons on a social networking platform.

16. The system of claim 10, wherein each geographic location is a city.

17. The system of claim 10, wherein each geographic location is a state.

18. The system of claim 10, wherein each geographic location is a neighborhood.

19. The system of claim 10, wherein the discount amount for coupons sold in each selected geographic location is determined based at least in part by comparing the number of coupons sold in each selected respective geographic location with the number of coupons sold in one or more other selected geographic locations.

20. A computer readable medium or media containing instructions for executing a method comprising:
using one or more computers, offering one or more discount coupons for sale for a predetermined period of time in a plurality of geographic locations, wherein each discount coupon enables a purchaser of the discount coupon to receive a discount on a specified product or service;
using one or more computers, determining a number of coupons sold in each geographic location;
using one or more computers, generating a display displaying a map showing at least the number of coupons sold in each geographic location;
using one or more computers, selecting one or more geographic locations where at least a predetermined minimum number of coupons have been sold; and
using one or more computers, setting a discount amount for coupons sold in each of the selected geographic locations where the predetermined minimum number of coupons were sold, wherein the discount amount for coupons sold in each selected geographic location is determined based at least in part on the number of coupons sold in each respective geographic location.
